(19) United States
(12) Patent Application Publication
(10) Pub. No.: US 2026/0065896 A1
(43) Pub. Date: Mar. 5, 2026

(54) METHOD AND APPARATUS FOR SPEECH SYNTHESIS FOR MULTILIGNUAL AND MULTISPEAKER

(71) Applicants: HYUNDAI MOTOR COMPANY, Seoul (KR); KIA CORPORATION, Seoul (KR)

(72) Inventor: Chang Hwan Kim, Hwaseong-si (KR)

(73) Assignees: HYUNDAI MOTOR COMPANY, Seoul (KR); KIA CORPORATION, Seoul (KR)

(21) Appl. No.: 19/190,349

(22) Filed: Apr. 25, 2025

(30) Foreign Application Priority Data
Aug. 28, 2024 (KR) 10-2024-0116055

(51) Int. Cl. G10L 13/10; G10L 25/30

(52) U.S. Cl. CPC G10L 13/10; G10L 25/30; G10L 2013/105

(57) ABSTRACT

A speech synthesis apparatus includes a memory configured to store language information configured by a user and audio samples of a speaker corresponding to speaker information selected by the user. The speech synthesis apparatus also includes a processor configured to generate an audio signal corresponding to input text by applying a speech synthesis model to the input text, the language information, and the audio samples in response to a speech synthesis request of the user. The speech synthesis model is trained to generate an audio signal including features of training text and features of a training audio signal. Language information of the training text and speaker information of the training audio signal are removed from the generated audio signal.

### CROSS-REFERENCE TO RELATED APPLICATIONS

This application claims the benefit of and priority to Korean Patent Application No. 10-2024-0116055, filed on Aug. 28, 2024, the entire contents of which are hereby incorporated herein by reference.

### TECHNICAL FIELD

The present disclosure relates to a speech synthesis method and an apparatus for multilingual and multispeaker.

### BACKGROUND

The statements in this section merely provide background information related to the present disclosure and do not necessarily constitute prior art.

Speech synthesis is a technology that generates sounds similar to human speech and is commonly known as Text To Speech (TTS) system. Speech synthesis technology delivers information to the user through speech signals rather than text or images, making it particularly useful when the user is unable to see the screen of a machine in operation, such as when the user is driving a car or when the user is blind.

Conventional speech synthesis methods include generating a spectrogram based on input text and generating a sound wave based on the spectrogram. Here, a spectrogram is a tool for visualizing and understanding a sound or a waveform that is obtained by converting an audio signal in the time domain into frequency components against the time domain axis. Based on the spectrogram, characteristics of a waveform and its spectrum may be visualized. Furthermore, the speech synthesis method may generate sound waves that reflect speech characteristics of the speaker. The speech synthesis method may generate a speech signal corresponding to the input text based on the attributes such as the speaker's voice, prosody, pitch, and speech rate.

Recently, a speech synthesis method that synthesizes speech from text based on an artificial neural network is getting attention. One popular speech synthesis method based on an artificial neural network is a flow-based method. The flow-based method estimates the likelihood for text by applying an invertible transformation.

It is difficult for a conventional speech synthesis model to synthesize speech of an unlearned (or unseen) speaker-language. Specifically, the training data used for training a conventional speech synthesis model consists of [text, speaker, language] pairs. Since most speakers speak in only one language, it is difficult for a speech synthesis model to generate a natural-sounding speech of a speaker in a different language. For example, a speech synthesis model trained based on speech data of a man speaking in English has limitations in synthesizing speech data representing a man speaking in Korean. In other words, conventional speech synthesis methods have many limitations in synthesizing natural-sounding speech that reflects the speaker's speech style, emotional expression, and so on.

To solve the issues due to synthesis of multiple languages, language embeddings may be additionally input to the text encoder included in the flow-based speech synthesis model in addition to input text. Based on the method above, it is possible for the speech synthesis model to learn multiple languages; however, a complex fine-tuning task is required in the subsequent stages of the speech synthesis model to generate high-quality speech. In addition, speaker and language embeddings may be additionally input to the duration predictor that predicts the speech duration of the input text in the flow-based speech synthesis model. Based on the method above, the speech synthesis model may learn the duration features of multiple languages. However, if a sentence is expressed in multiple languages, predicted speech duration may become unstable.

### SUMMARY

Embodiments of the present disclosure provide a speech synthesis method and an apparatus for generating multi-speaker/multi-lingual speech with more accurate pronunciation in a vehicle environment. The speech synthesis method and the apparatus train a speech synthesis model to exclude speaker and language information from text during the training stage and add speaker and language features to the text during the inference stage.

At least one aspect of the present disclosure provides a speech synthesis apparatus. The speech synthesis apparatus includes a memory configured to store language information configured by a user and audio samples of a speaker corresponding to speaker information selected by the user. The speech synthesis apparatus also includes a processor configured to generate an audio signal corresponding to input text by applying a speech synthesis model to the input text, the language information, and the audio samples in response to a speech synthesis request of the user. The speech synthesis model is trained to generate an audio signal including features of training text and features of a training audio signal. Language information of the training text and speaker information of the training audio signal are removed from the generated audio signal.

Another aspect of the present disclosure provides a speech synthesis method performed by a speech synthesis apparatus. The speech synthesis method includes receiving a speech synthesis request for input text, wherein the speech synthesis request includes language information and speaker information configured by a user. The speech synthesis method also includes generating an audio signal corresponding to the input text by applying a speech synthesis model to the input text, the language information, and audio samples of a speaker corresponding to the speaker information. The speech synthesis model is trained to generate an audio signal including features of training text and features of a training audio signal. Language information of the training text and speaker information of the training audio signal are removed from the generated audio signal.

As described above, embodiments of the present disclosure provide a speech synthesis method and an apparatus for generating multi-speaker/multi-lingual speech with more accurate pronunciation in a vehicle environment. The speech synthesis method and the apparatus train a speech synthesis model to exclude speaker and language information from text during the training stage and add speaker and language features to the text during the inference stage. Thus, complex fine-tuning may be eliminated after the training stage, and quality of synthesized speech may be improved.

According to embodiments of the present disclosure, even if a sentence contains multiple languages, a vehicle passenger may still receive a synthesized speech guidance tailored to their preferred speaker and language features.

### BRIEF DESCRIPTION OF THE DRAWINGS

FIG. 1 illustrates the structure of a vehicle according to one embodiment of the present disclosure.

FIG. 2 illustrates a speech synthesis system according to one embodiment of the present disclosure.

FIG. 3 illustrates training of a speech synthesis model according to one embodiment of the present disclosure.

FIG. 4 illustrates a duration loss according to one embodiment of the present disclosure.

FIG. 5 illustrates the operation of a speech synthesis model according to one embodiment of the present disclosure.

FIG. 6 is a flow diagram illustrating a speech synthesis method according to one embodiment of the present disclosure.

### DETAILED DESCRIPTION

Hereinafter, some embodiments of the present disclosure are described in detail with reference to the accompanying illustrative drawings. In the accompanying drawings, like reference numerals designate like elements, even when the elements are shown in different drawings. Further, in the following description of some embodiments, detailed descriptions of related known components and functions, when considered to obscure the subject of the present disclosure, have been omitted for the purpose of clarity and for brevity.

Additionally, various terms such as first, second, A, B, (a), (b), etc., are used solely to differentiate one component from the other but not to imply or suggest the substances, order, or sequence of the components. Throughout this specification, when a part ‘includes’ or ‘comprises’ a component, the part is meant to further include other components, not to exclude thereof unless specifically stated to the contrary. The terms such as ‘unit’, ‘module’, and the like refer to one or more units for processing at least one function or operation, and may be implemented by hardware, software, or a combination thereof.

Each constituting element of an apparatus or a method according to embodiments of the present disclosure may be implemented by hardware, software, or a combination of hardware and software. Also, the function of each constituting element may be implemented by software, and a microprocessor may execute the function of the software corresponding to each constituting element.

When a component, device, element, or the like of the present disclosure is described as having a purpose or performing an operation, function, or the like, the component, device, or element should be considered herein as being “configured to” meet that purpose or perform that operation or function.

The detailed descriptions provided below together with the accompanying drawings are intended only to explain illustrative embodiments of the present disclosure, which should not be regarded as the sole embodiments of the present disclosure.

The present disclosure relates to speech synthesis for multi-lingual and multi-speaker. Embodiments of the present disclosure provide a speech synthesis method and an apparatus for generating multi-speaker/multi-lingual speech with more accurate pronunciation in a vehicle environment. The speech synthesis method and the apparatus train a speech synthesis model to exclude speaker and language information from text during the training stage and add speaker and language features to the text during the inference stage.

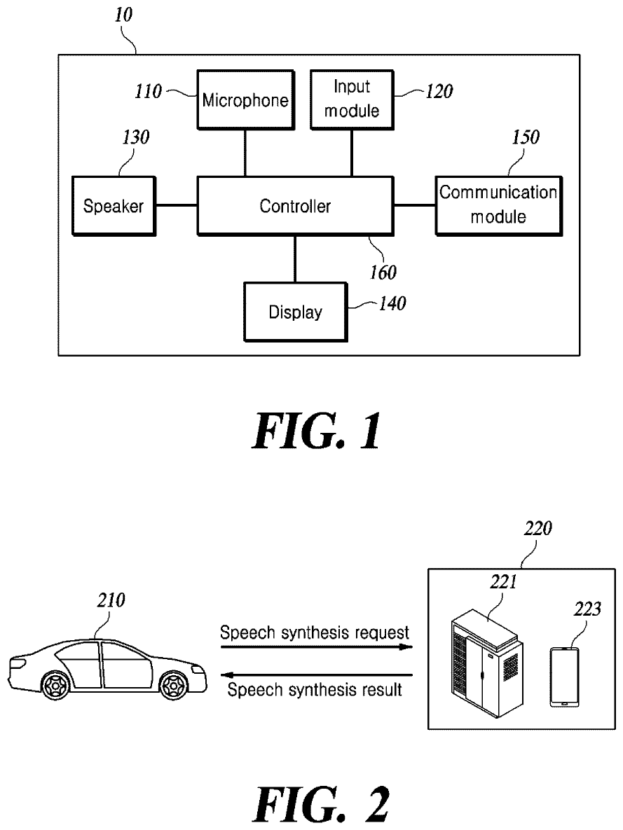

FIG. 1 illustrates the structure of a vehicle according to one embodiment of the present disclosure.

Referring to FIG. 1, a vehicle 10 comprises a microphone 110 through which a user's voice is input, an input module 120 receiving vehicle information, a speaker 130 outputting a sound necessary for providing a service desired by the user, a display 140 displaying an image that may be necessary for providing a service desired by the user, a communication module 150 performing communication with an external device, and a controller 160 controlling the constituting elements above and other constituting elements of the vehicle.

The microphone 110 may be provided at a location inside the vehicle 10 where the user's voice is input. The user who inputs voice into the microphone 110 provided in the vehicle 10 may be the driver. The microphone 110 may be installed at a location such as the steering wheel, center fascia, headlining, or rearview mirror to receive the driver's voice.

In addition to the user's voice, various audio sounds generated around the microphone 110 may be input to the microphone 110. The microphone 110 outputs an audio signal corresponding to the input audio signal. The output audio signal may be processed by the controller 160 or transmitted to an external server device through the communication module 150.

In addition to the microphone 110, the vehicle 10 may include an input module 120 for receiving user commands. The input module 120 may be provided in the form of a button or a jog shuttle in the cluster area, the AVN (Audio, Video, Navigation) area of the center fascia, the gearbox area, or the steering wheel.

To receive control commands related to the passenger seat, the input module 120 may include an interface device provided on the door of each seat and an interface device provided on the armrest of the front seat or the armrest of the rear seat.

The input module 120 may include a touch pad integrated with the display 140 to implement a touch screen.

The input module 120 may include a camera. The camera may acquire at least one of an internal image or an external image of the vehicle 10. The camera may be installed inside, outside, or both inside and outside of the vehicle 10. The images collected by the camera are processed by the controller 160 or an external server device; based on the collected images, the gaze, mouth shape, face, behavior, or state of the occupant in the video may be analyzed.

The speaker 130 outputs an electrical signal in the form of a sound wave. The speaker 130 may be disposed to face the inside of the vehicle 10 near each door, roof, front window, or rear window. The speaker 130 may refer to various types of speakers, such as loudspeakers and array speakers.

The display 140 may include an AVN display, a cluster display, or a head-up display (HUD) provided on the center fascia of the vehicle 10. Alternatively, the display 140 may include a rear seat display provided on the back of the headrest of the front seat for passengers in the rear seat. Alternatively, when the vehicle 10 is a multi-passenger vehicle, the display 140 may include a display mounted on the headlining.

The display 140 needs to be provided in locations where the occupants of the vehicle 10 may see it, and there are no other restrictions on the number or location of the displays 140.

The communication module 150 may exchange signals with other devices by employing at least one of various wireless communication methods such as Bluetooth, 4G communication, 5G communication, or Wi-Fi. Alternatively, or additionally, the communication module 150 may exchange information with other devices through a cable connected to a Universal Serial Bus (USB) port, auxiliary (AUX) port, and so on.

Also, the communication module 150, by being equipped with two or more communication interfaces that support different communication methods, may exchange information signals with two or more other devices.

For example, the communication module 150 may communicate with a mobile device located inside the vehicle 10 through Bluetooth communication to receive information (user's video, voice, contact information, schedule, and so on) obtained by the mobile device or stored therein; transmit the user's voice by communicating with the server 1 through the 4G or 5G communication, and receive signals necessary to provide a service desired by the user. Also, the communication module 150 may exchange necessary signals with the server 1 through a mobile device connected to the vehicle 10.

In addition to the above, the vehicle 10 may include a navigation device for providing route guidance, an air conditioning device for controlling the internal temperature, a window control device for controlling opening/closing of windows, a seat heating device for warming up the seats, a seat positioning device for adjusting the position, height, or angle of the seats, and a lighting device for adjusting internal illumination.

The devices described above provide convenience functions related to the vehicle 10, and some of the devices may be omitted depending on the vehicle model and options. Also, it should be noted that other devices may be included in addition to the devices described above. For driving of the vehicle 10, well-known configurations are employed, and description thereof has been omitted in the present disclosure.

The controller 160 may turn on/off the microphone 110. The controller 160 may process or store the voice input to the microphone 110 or transmit the input voice to another device through the communication module 150.

The controller 160 may control images to be displayed on the display 140 and control sounds to be output to the speaker 130.

The controller 160 may perform various control operations related to the vehicle 10. For example, according to a user's command input through the microphone 110 or the input module 120, the controller 160 may control at least one of the navigation device, the air conditioning device, the window control device, the seat heating device, the seat positioning device, or the lighting device.

The controller 160 may include at least one memory that stores a program for performing the operation above as well as those described in more detail below. The controller 160 may also include at least one processor that executes the stored program.

In the following description, intra-lingual synthesis refers to the speech synthesis from text in a language spoken by a speaker represented in a speaker embedding. For example, intra-lingual synthesis corresponds to the speech synthesis from Korean text by a Korean speaker.

Cross-lingual synthesis refers to the speech synthesis from text in a language that a speaker represented in the speaker embedding does not speak. For example, cross-lingual synthesis corresponds to the speech synthesis from Korean text by an English speaker.

Code-mixed synthesis refers to the speech synthesis from text in multiple languages. For example, code-mixed synthesis corresponds to the speech synthesis from “Korean+English” text by a Korean speaker.

In an example, in the training stage of a speech synthesis model, intra-lingual synthesis may be mainly applied. In the inference stage of the speech synthesis model, code-mixed synthesis may be performed in addition to intra-lingual synthesis and cross-lingual synthesis.

According to an embodiment of the present disclosure, the controller 160 may operate as a speech synthesis apparatus. For example, a user may request audio output as if text displayed on the display 140 were spoken by a preferred speaker in a preferred language. The language and speaker preferred by the user may be preconfigured. The controller 160 may synthesize speech corresponding to the text by converting the text into an audio signal according to a requested speaker in a requested language. In other words, the controller 160 may perform intra-lingual synthesis or cross-lingual synthesis. The user may hear a natural-sounding speech as if a selected speaker naturally spoke the selected text. In another example, if the user requests speech recognition by saying, “What is ‘Encantado de conocerlo’ in English?”, the controller 160 may perform code-mixed synthesis to generate “Encantado de conocerlo is Nice to meet you in English.” The controller 160 may obtain pre-stored audio samples and may apply a speech synthesis model to the multilingual text and audio samples. To process multilingual text, the controller 160 may configure languages included in the multilingual text. The speech synthesis model may generate an audio signal as if multilingual text were spoken naturally in multiple languages. The audio signal may be output through the speaker 130. The user may hear natural-sounding speech as if a selected speaker naturally spoke the multilingual text

In another example, the controller 160 may synthesize and convert the user's voice or text according to a different speaker and language.

According to another embodiment, the controller 160 and the communication module 150 may provide a speech synthesis function in conjunction with an electronic device located outside the vehicle 10.

FIG. 2 illustrates a speech synthesis according to one embodiment of the present disclosure.

Referring to FIG. 2, a speech synthesis system according to an embodiment includes a vehicle 210 and an electronic device 220. A speech synthesis method according to an embodiment may be implemented by the vehicle 210 and the electronic device 220. The speech synthesis model may be implemented on the electronic device 220. The speech synthesis method may be performed by the electronic device 220.

The electronic device 220 may perform speech synthesis. The electronic device 220 may be implemented by at least one of the server device 221 or the mobile terminal 223.

The vehicle 210 may transmit a speech synthesis request to the electronic device 220. The electronic device 220 may respond to the vehicle 210 with an audio signal, which is the speech synthesis result. The speech synthesis request includes text to be synthesized into a speech, language information for the text, and speaker information.

For example, the vehicle 210 may transmit a speech synthesis request including a set consisting of [text, speaker] or [text, speaker, language] pairs to the electronic device 220. The electronic device 220 may generate an audio signal indicating that the requested text is spoken by a selected speaker. Since it is not the case that an actual speaker utters the text, the audio signal is generated data rather than recorded data. However, the audio signal may contain natural pronunciation and voice, as if it were a recording of an actual speaker speaking fluently in a requested language. The electronic device 220 may transmit the generated audio signal as a result of speech synthesis to the vehicle 210. The vehicle 210 may reproduce the received audio signal, thereby outputting the audio signal according to the text, speaker, and language requested by the user. As described above, in the case of code-mixed synthesis (i.e., when text contains words or characters from multiple languages), language information may be configured for each word or character.

In an embodiment, the electronic device 220 may include a processor and a memory for speech synthesis.

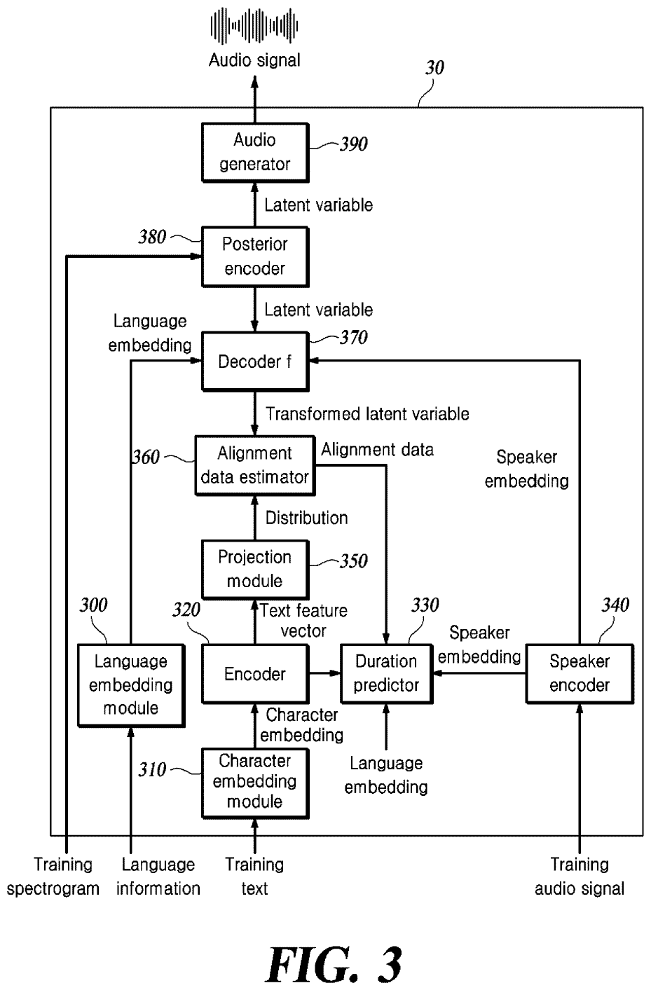

FIG. 3 illustrates training of a speech synthesis model according to one embodiment of the present disclosure.

Referring to FIG. 3, a model architecture 30 is illustrated for a training stage of a speech synthesis model. In the training stage, the model architecture 30 may include a language embedding module 300, a character embedding module 310, an encoder 320, a duration predictor 330, a speaker encoder 340, a projection module 350, an alignment data estimator 360, a decoder 370, a posterior encoder 380, and an audio generator 390. In other embodiments, a portion of the constituting elements included in the model architecture 30 may be omitted and/or the order of the constituting elements may be changed. The model architecture 30 may further include a discriminator (not shown). The model architecture 30 may additionally include a trainer (not shown) for training the speech synthesis model or may be implemented by being linked to an external trainer. In an embodiment, the posterior encoder 380, discriminator, and trainer are used only for training the speech synthesis model.

In embodiments of the present disclosure, conditioning of an embedding may mean adding, multiplying, or subtracting an embedding to or from an input or internal element. To ensure dimensionality matching, the dimension size of the embedding may be adjusted by a neural network layer (e.g., a fully connected layer or a convolutional layer). For example, in the duration predictor 330, a language embedding may be added to a text feature vector.

For training the speech synthesis model, a training dataset may be prepared in advance. The training data set may include text data, audio data corresponding to the text data, and language data. The audio data may be a recording of text data actually spoken by multiple speakers. The training data may include pairs of [training text, speaker's training audio signal, language]. However, since most speakers may speak only a small number of languages, training data that includes [text, speaker's audio signal, language] may be sparse. In other words, multispeaker-multilingual datasets may be sparse.

The training text may include a sequence of characters in a natural language. For example, the sequence of characters may include alphabetic characters, numbers, punctuation marks, or other special characters. The audio data corresponding to text data is a recording of text data actually spoken by multiple speakers.

The training audio signal represents the speech data of speakers. The speaker refers to the person who spoke the audio data corresponding to the text data. The training audio signal may include vocal characteristics and/or speech characteristics of a speaker. A speaker's speech characteristics may include at least one of various elements such as speech speed, pause intervals, pitch, tone, prosody, intonation, pronunciation, or emotion. Audio signals of multiple speakers may be prepared. Since the training audio signal represents the speech characteristics of a specific speaker, the training audio signal may be different from the audio data corresponding to the training text.

Furthermore, linear-spectrograms or Mel-spectrograms converted from audio data may be prepared in advance to be used as the ground truth during the training stage. Linear-spectrograms may be generated by applying the short-time Fourier transform (STFT), discrete Fourier transform (DFT), or fast Fourier transform (FFT) to the audio data. A Mel-spectrogram may be obtained by adjusting the frequency interval of the linear-spectrogram to the Mel-scale. The Mel-spectrogram may be obtained by applying a Mel-filterbank to the linear spectrogram. Linear-spectrograms or Mel-spectrograms may be used for the calculation of reconfiguration loss described later.

Language information refers to the language of text data. The language information may be represented as a number. For example, the language information may include Korean, English, German, Japanese, and Chinese. Korean may be denoted as 1, English as 2, and German as 3.

FIG. 3 illustrates a process in which training text, a training audio signal, a training spectrogram, and language information within the training dataset are processed for training.

The speaker encoder 340 may transform or map the speaker's training audio signal into a speaker embedding. A speaker embedding represents the speaker's speech characteristics and may be expressed in a vector form. Also, the speaker embedding may include speaker identification information.

The speaker encoder 340 may represent discontinuous data values included in speaker information as a vector composed of consecutive numbers. For example, the speaker encoder 340 may generate a speaker embedding vector based on a combination of at least one or two or more of various artificial neural network models, including a pre-net, a CBHG module, a deep neural network (DNN), a convolutional neural network (CNN), a recurrent neural network (RNN), a long short-term memory network (LSTM), and a Bidirectional Recurrent Deep Neural Network (BRDNN).

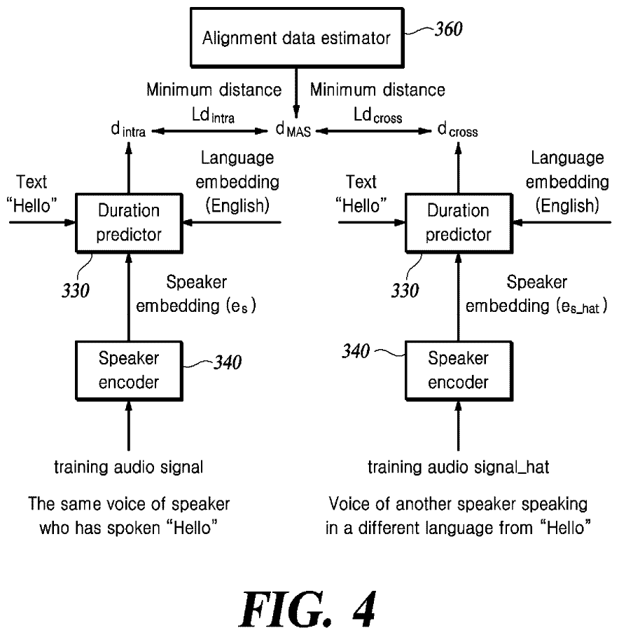

As shown in FIG. 4, the speaker encoder 340 may generate a speaker embedding(es) by using the voice of a speaker who has spoken the training text of the encoder 320. Also, the speaker encoder 340 may generate a speaker embedding (e_{s_hat}) by using the voice of another speaker speaking in a different language from the one used for the training text.

The language embedding module 300 may transform the language information corresponding to training text into a language embedding. For example, the language embedding module 300 may map the language information to a language embedding using one-hot encoding. The language embedding may be in a vector form. Since one-hot encoding is a widely known technology in the field of speech synthesis, detailed descriptions thereof has been omitted.

The character embedding module 310 may transform or map training text into a character embedding. In an example, training text may be composed in sentence or character units. The character embedding module 310 may separate the training text into character units and transform each separated text into a character embedding. Alternatively, the character embedding module 310 may separate the training text into alphabet units or phoneme units and then may transform them into character embeddings. For example, the character embedding module 310 may perform character embedding using an artificial neural network model. Character embeddings may be represented as learnable vectors.

The encoder 320 may extract text feature vectors from character embeddings. Text feature vectors extracted by the encoder 320 may include features of character embeddings, i.e., the training text.

In one embodiment, the encoder 320 may perform encoding in phoneme units. To this end, the encoder 320 may separate the character embeddings into phoneme units of the training text. In another embodiment, the encoder 320 may perform encoding on the entire set of character embeddings.

The encoder 320 may comprise an artificial neural network. For example, the encoder 320 may be a transform-based encoder 320. The transform-based encoder 320 may include a plurality of transformer blocks, and each transformer block may include at least one encoder 320, at least one decoder, and an attention module. For example, the transform-based encoder 320 may include 10 transformer blocks. The transformer block may extract context vectors from character embeddings using the encoder 320, may identify important character embeddings using the attention module, and may generate text feature vectors from a context vector and the outputs of the attention module using the decoder 370.

The projection module 350 may output the distribution of text feature vectors to match dimensions before element-wise summation. The distribution of text feature vectors may be a prior distribution including the means and standard deviations of the text feature vectors. The distribution may include the mean and standard deviation of each text feature vector corresponding to each phoneme. The projection module 350 may be a linear projection layer.

The posterior encoder 380 may encode training spectrograms and may output latent variables. Encoding may include extracting features from existing data and transforming the features into data with reduced size or dimensionality compared to existing data. In other words, the result output through encoding may be the result obtained by compression of the input data. The latent variable may be a latent vector. Latent variables include the speaker's voice and/or speech characteristics. Also, the latent variable includes linguistic characteristics.

The training spectrograms may be linear-scale spectrograms or Mel-spectrograms transformed from audio data corresponding to the text data. In another embodiment, an audio file format such as wav or mp3 is input to the posterior encoder 380, and the posterior encoder 380 may encode the audio signal to extract a latent vector.

The posterior encoder 380 may comprise a deep neural network. For example, the posterior encoder 380 may be a Variational Auto-Encoder (VAE) encoder. The posterior encoder 380 may include non-causal WaveNet residual blocks used in the WaveGlow model and the Glow-TTS model. For example, the posterior encoder 380 may include 12 WaveNet residual blocks. The non-causal WaveNet residual block may include an extended convolutional layer with gated activation units and skip connections. A linear projection layer on top of the block may generate the mean and variance of the normal posterior distribution.

The decoder 370 may output transformed latent variables based on the latent variables, language embeddings, and speaker embeddings. The decoder 370 may generate a latent variable having a distribution different from the prior distribution of the latent variable. The different distribution may be a normal distribution.

The decoder 370 may remove speaker information and language information from the latent variables. For example, the decoder 370 may receive language embeddings corresponding to training text and speaker embeddings corresponding to the training audio signal. The decoder 370 may remove speaker and language-related features within the latent variables by normalizing the speaker and language-related information of the latent variables. In an example, removal of speaker and language information may be performed based on the feature-ratio normalization (FRN) of Equation 1.

$$SN ( x , {e}_{s} ) = \frac{x - m ( {e}_{s} )}{exp ( v ( {e}_{s} ) )} LN ( x , {e}_{l} ) = \frac{x - m ( {e}_{l} )}{exp ( v ( {e}_{l} ) )} FRN = ρ \cdot SN + ( 1 - ρ ) \cdot LN \qquad [ Equation 1 ]$$

In Equation 1, SN(x,g) represents the result of speaker normalization (SN). x is a normalization target and may be a latent variable. eₛ represents speaker embedding, m(eₛ) represents the mean of speaker embedding, and v(eₛ) represents the variance of speaker embedding. The mean and the variance of speaker embedding may be calculated for the entire dataset used for training. According to speaker normalization, the latent variable excludes the speaker features eₛ. Speaker normalization may be applied to partial dimensions of the latent variable.

LN(x,eₗ) represents the result of language normalization (LN). x is a normalization target and may be a latent variable. eₗ represents language embedding, m(eₗ) represents the mean of language embedding, and v(eₗ) represents the variance of language embedding. The mean and the variance of language embedding may be calculated for the entire dataset used for training. According to language normalization, the latent variable excludes the language features eₗ. Language normalization may be applied to partial dimensions of the latent variable.

FRN is defined as a linear weighted sum of SN and LN. The feature ratio ρ may be calculated based on the mean and the variance of speaker embedding and the mean and the variance of language embedding. For example, the feature ratio ρ may be estimated based on the output of a neural network layer that uses the mean and the variance of speaker embedding and the mean and the variance of language embedding as inputs. The neural network layer may be trained. According to Equation 1, features of the speaker and language embeddings may be excluded from the latent variable.

In this way, the decoder 370 may normalize speaker and language-related features in the latent variable based on the speaker and language embeddings and may generate a transformed latent variable by sampling the latent variable from a simpler or more complex distribution than the distribution of the preprocessed latent variable. Here, the preprocessing refers to the normalization of the speaker and language embeddings. The decoder 370 may remove the language information of the training text and the speaker information of the training audio signal within the latent variable by normalizing the latent variable based on the speaker and language embeddings. The transformed latent variable includes the features of the training audio signal but may not include the language information of the training text and the speaker information of the training audio signal.

The decoder 370 may comprise a normalizing flow function. The decoder 370 may obtain the transformed latent variable by applying the function f to the preprocessed latent variable. Since the distribution transform of the decoder 370 is reversible, an inverse function for the decoder f may be defined. The transformed latent variable may have the same, a different, or a more complex distribution compared to the original latent variable. Here, the complex distribution means a distribution with multiple local minima and maxima, unlike a simple normal distribution.

The decoder 370 may comprise a deep neural network. For example, the decoder 370 may be a flow-based decoder. The decoder 370 may include a plurality of affine coupling layers. For example, the decoder 370 may include four affine coupling layers. A portion of the plurality of affine coupling layers may be used for the exclusion of the speaker and language embeddings.

The affine coupling layer for the exclusion of speaker and language information may be referred to as a Speaker-Language Normalized Affine Coupling Layer (SLNAC). The speaker-language normalized affine coupling layer may obtain a speaker-language normalization result from the latent variable according to Equation 1. In one embodiment, the affine coupling layer may generate an output latent variable by applying speaker-language normalization to a portion of dimensions of the input latent variable, applying the affine transform to the normalization result based on scale and bias parameters, and combining the transform result with a speaker-language normalization result for the remaining dimensions of the input latent variable. The affine coupling layer is easily invertible and has a triangular Jacobian matrix; the determinant may be calculated based on the Jacobin expression, from which the model density q may be easily calculated.

As described above, the decoder 380 may generate a transformed latent variable normalized using the speaker and language embeddings.

The alignment data estimator 360 may output alignment data based on the distribution of text feature vectors and the transformed latent variable.

In an example, the alignment data estimator 360 may estimate a matrix for sorting the duration of each phoneme of the training text based on the mean values, standard deviation values, and transformed latent variables of the text feature vectors as alignment data. The alignment data's dimensionality may depend on the length of the latent variable and the length of the character embedding. For example, rows may represent phonemes, while columns may represent time intervals. In the alignment data, the duration of each phoneme is expressed in the form of a path; elements along the path have a value of 1, while other elements have a value of 0. In other words, alignment data refers to alignment information between phonemes of training text and their respective latent variables.

To estimate matrix A, which is the alignment data between phonemes included in the training text, Monotonic Alignment Search (MAS), a method of searching for alignment that maximizes the likelihood of data parameterized by a flow normalization function, may be used. The alignment data estimator 360 may estimate alignment data by applying the MAS method to the distribution of text feature vectors and transformed latent variables. Since the MAS method is a widely known method, detailed descriptions thereof has been omitted.

The alignment data may be used to train the duration predictor 330. The alignment data may refer to the similarity between text feature vectors and the transformed latent variable.

The duration predictor 330 may receive text feature vectors, speaker embeddings, and language embeddings and, based on the received input, predicts the duration of each phoneme in the training text. In other words, the duration predictor 330 may predict phoneme duration data.

The duration predictor 330 may use speaker embeddings as conditioning information. The duration predictor 330 may condition speaker embeddings during the calculation process. For example, speaker embeddings may be added or multiplied to text feature vectors.

The duration predictor 330 may use language embeddings as conditioning information. The duration predictor 330 may condition language embeddings during the calculation process. For example, language embeddings may be added or multiplied to text feature vectors.

As shown in FIG. 4, in an embodiment, the duration estimator 330 uses a speaker embedding(eₛ) based on the voice of a speaker who has spoken the training text or a speaker embedding (e_{s_hat}) based on the voice of another speaker speaking in a different language from the language used for the training text. By using the speaker embedding (e_{s_hat}) based on the voice of another speaker speaking in a different language from the one used for the input sentences, the duration predictor 330 may utilize the language information inherent in the text and language embedding but may ignore the language information inherent in the speaker embedding. Afterward, in the inference stage of the speech synthesis model, even if a sentence includes multiple languages, the duration predictor 330 may stably generate the duration of a phoneme.

The audio generator 390 may generate an audio signal in the time domain based on latent variables. In other words, the audio generator 390 may generate a speech waveform based on the prior distribution of latent variables.

The audio generator 390 may comprise a deep neural network. The audio generator 390 may be a vocoder. For example, the audio generator 390 may be a HiFi-GAN generator. The audio generator 390 may include a stack of transposed convolutions, each convolution possibly followed by a multi-receptive field fusion (MRF) module. The output of MRF is a sum of the outputs of ‘residual blocks’ with varying receptive field sizes. The audio generator 390 may include a linear layer responsible for transforming speaker embeddings, may add the speaker embeddings to the latent variable z, and may generate an audio signal from the combination of the latent variable and the speaker embeddings.

End-to-end training may be applied to the architecture 30 of the speech synthesis model described above. The architecture 30 of the speech synthesis model may be trained by a computer-implemented training device. A discriminator may be used for training of the audio generator 390. The discriminator may be the HiFi-discriminator.

In one embodiment, as a loss function of the speech synthesis model, at least one of reconstruction loss, Kullback-Leibler divergence loss, duration loss, adversarial loss, and feature matching loss may be used.

The reconstruction loss may be calculated based on the difference between the spectrogram for the generated audio signal and the training spectrogram. As described above, a transformer may be additionally used to transform the generated audio signal into a spectrogram. Also, the training spectrogram may be generated from the audio data corresponding to the training text.

The KL divergence loss may be calculated based on the difference between the latent variable and the text feature vectors. The KL divergence loss may be calculated based on the difference between the posterior probability of the latent variable and the conditional prior probability for the text feature vector. In other words, KL divergence loss may refer to the similarity between the distribution of the latent variable and the distribution of the text feature vector.

The duration loss may be calculated based on the difference between the phoneme duration data predicted by the duration predictor 430 and the duration of the phoneme generated by the alignment data estimator 360. As described above, the alignment data generated by the alignment data estimator 360 may include the duration d_{MAS} of phonemes. Duration loss may be calculated based on the Mean Square Error (MSE). The duration loss is intended to enable the duration predictor 330 to predict the duration of each phoneme conditioned on both the speaker and language. As shown in FIG. 4, the duration predictor 330 may generate the duration dᵢₙₜᵣₐ by using the speaker embedding eₛ according to the voice of the speaker who has spoken the training text. Alternatively, the duration predictor 330 may generate the duration d_{cross} by using the speaker embedding e_{s_hat} according to the voice of another speaker in a different language from the one used for the input sentence training text. As shown in FIG. 4, the duration loss is defined as the minimum length Ldᵢₙₜᵣₐ or Ld_{cross} depending on the speaker embedding (eₛ or e_{s_hat}) used. Alternatively, the duration loss may include both Ldᵢₙₜᵣₐ and Ld_{cross}. By utilizing the speaker embedding eₛ based on the voice of a speaker who has spoken the input sentence and the speaker embedding e_{s_hat} based on the voice of another speaker in a different language from the one used for the input sentence, the trainer may utilize the language information inherent in the text and language embedding, but exclude the language information inherent in the speaker embedding. As a result, in the inference stage of the speech synthesis model, even if a sentence includes multiple languages, the duration predictor 330 may stably generate the duration of a phoneme.

The adversarial loss may be calculated based on the discriminator's determination on whether an audio signal generated by the audio generator 390 is genuine. To reduce the adversarial loss, it is necessary for the discriminator to determine the generated audio signal as genuine data. The adversarial loss causes the discriminator to output a value of 1 in response to an input of real data and output a value of 0 in response to an input of fake data. The feature matching loss may be calculated based on the difference between features extracted by the discriminator from the generated audio signal and features extracted by the discriminator from the actual audio signal.

Through training based on the adversarial loss and feature matching loss, the audio generator 390 may generate audio signals almost identical to actual data.

The loss function of the model architecture 30 may further include speaker consistency loss (SCL). Speaker consistency loss is calculated based on the difference between the output of the speaker encoder 340 and the ground-truth. In other embodiments, the speaker encoder 340 may be pre-trained.

In another embodiment, the reconstruction loss alone may be used as a loss function. Through end-to-end learning, model architecture 30 may be updated based on the difference between audio signals generated by the model architecture 30 from training text and labeled audio samples corresponding to the training text.

The trainer may update the model architecture 30 in the direction that decreases the loss function above. Through iterative training based on the overall loss function, each component of the model architecture 30 is refined, enabling the speech synthesis model to generate natural speech signals of the speaker.

Through the training process described above, the speech synthesis model becomes robust to speaker and language diversity. In particular, dependency on specific speaker and language is reduced. In other words, the speech synthesis model is trained based on text rather than specific speakers and languages. Afterward, during the inference stage of the speech synthesis model, the speech synthesis model utilizes speaker and language information. In learning the durations of phonemes, the speech synthesis model may exclude the language information inherent in the speaker embeddings.

Even if the speech synthesis model receives a code-mixed text, the speech synthesis model may generate a natural-sounding voice of a speaker from text using the speaker and language information. For example, even if the training dataset has a substantial amount of [Korean text, Korean voice] data and only a limited amount of [English text, Korean voice] data, the speech synthesis model still learns the context of Korean/English text and speech features without relying on speaker and language information. Then, in the inference stage, the speech synthesis model may synthesize a natural-sounding speech by adding speaker and language embeddings to the [code-mixed text].

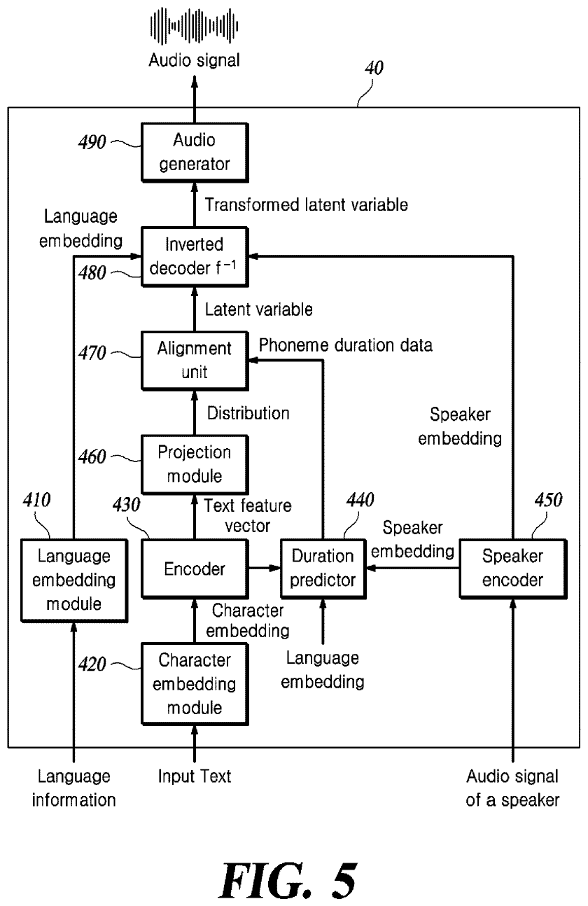

FIG. 5 illustrates the operation of a speech synthesis model according to one embodiment of the present disclosure.

Referring to FIG. 5, the configurations of the speech synthesis model 40 are shown. The speech synthesis model 40 may generate an audio signal as if the input text in a given language were spoken by a specific speaker. Specifically, the speech synthesis apparatus stores language information set by the user and pre-recorded audio samples of a selected speaker. The content of the audio samples may differ from that of the input text. The speech synthesis apparatus may synthesize an audio signal by applying the speech synthesis model to language information, the speaker's audio signals, and the target text.

In the inference stage, the speech synthesis model 40 may include a language embedding module 410, a character embedding module 420, an encoder 430, a duration predictor 440, a speaker encoder 450, and a projection module 460, an alignment unit 470, an inverted decoder 480, and an audio generator 490.

The speech synthesis model 40 may be trained by the method of FIG. 3. The language embedding module 410, character embedding module 420, encoder 430, duration predictor 440, speaker encoder 450, projection module 460, inverted decoder 480, and audio generator 490 of FIG. 5 correspond to the language embedding module 300, character embedding module 310, encoder 320, duration predictor 330, speaker encoder 340, projection module 350, decoder 370, and audio generator 390 of FIG. 3. The inverted decoder 480 represents the inverse function of the decoder.

The language embedding module 410 may convert the language information of input text into language embeddings. In one embodiment, the language embedding module 410 may be omitted, and language embeddings corresponding to various languages may be stored in advance. In other words, a language embedding corresponding to the language information of the input text may be pre-stored, and the inverted decoder 480 may receive the language embedding. For example, in the case of cross-lingual synthesis, the language of the input text may differ from the language of the speaker's audio signal. The language embedding module 410 may generate a language embedding for each word. For example, in the case of code-mixed synthesis, input text may include words or characters corresponding to multiple languages. The language embedding module 410 may generate a language embedding for each word or character.

The character embedding module 420 may transform given input text into character embeddings. The input text may be mapped to a variable space for character embeddings.

The encoder 430 may output text feature vectors for the input text by encoding character embeddings. Text feature vectors include features of each phoneme of the input text.

The speaker encoder 450 may receive an audio signal recording the voice of a selected speaker and may output a speaker embedding by encoding the audio signal. The speaker embedding may include the speaker's voice and/or speech characteristics.

The duration predictor 440 may predict the duration of each phoneme of the input text based on text feature vectors, a speaker embedding and a language embedding, and outputs phoneme duration data including the duration of the phonemes. The phoneme duration data may include predicted duration for each phoneme based on the language features and voice and/or speech features of the speaker. When duration of each phoneme of the input text is generated, the duration predictor may utilize the language information inherent in the input text and the language embedding but excludes the language information inherent in the speaker embedding.

The phoneme duration data may be input to the alignment unit 470.

The projection module 460 may generate the distribution of text feature vectors. The distribution of text feature vectors may include means and standard deviations of the text feature vectors. In this process, the text feature vector may be transformed to match the dimensionality of the alignment data of the alignment unit 470. The dimensionality of data representing the distribution may correspond to one of the dimensions of the alignment data.

The alignment unit 470 may generate latent variables based on the distribution of text feature vectors and phoneme duration data. Latent variables may be generated from text feature vectors based on the phoneme duration data. For example, the alignment unit 470 may operate the mean and standard deviation of text feature vectors corresponding to each phoneme with the alignment data and may output a latent variable as a result of operation. The latent variable may include features of each phoneme of the input text and features related to the duration of each phoneme.

The inverted decoder 480 may generate a transformed latent variable based on the latent variable, language embedding, and speaker embedding. Since the inverted decoder 480 is trained for speaker normalization and language normalization to exclude speaker and language information during the training stage, a speaker embedding based on an audio signal of a speaker and a language embedding based on input text have to be incorporated into the latent variable during the inference stage.

A portion of affine coupling layers within the inverted decoder 480 may be used for denormalization of speaker and language embeddings. The corresponding affine coupling layer may be referred to as a speaker-language denormalized affine coupling layer. In an example, speaker and language embeddings may be incorporated into the latent variable based on feature-ratio denormalization (FRDN) of Equation 2.

$$FRDN = \frac{exp ( v ( {e}_{s} ) ) \cdot exp ( ν ( {e}_{l} ) )}{ρ \cdot exp ( v ( {e}_{l} ) ) + ( 1 - ρ ) \cdot exp ( v ( {e}_{s} ) )} \cdot x + \frac{ρ \cdot exp ( v ( {e}_{l} ) ) \cdot m ( {e}_{s} ) + ( 1 - ρ ) \cdot exp ( v ( {e}_{s} ) ) \cdot m ( {e}_{l} )}{ρ \cdot exp ( v ( {e}_{l} ) ) + ( 1 - ρ ) exp ( v ( {e}_{s} ) )} SDN ( x , {e}_{s} ) = x \cdot exp ( v ( {e}_{s} ) ) + m ( {e}_{s} ) LDN ( x , {e}_{l} ) = x \cdot exp ( v ( {e}_{l} ) ) + m ( {e}_{l} ) \qquad [ Equation 2 ]$$

In Equation 2, x is a target of denormalization, which may be a latent variable. eₛ represents the speaker embedding, m(eₛ) represents the mean of the speaker embedding, and v(eₛ) represents the variance of the speaker embedding. eₗ represents the language embedding, m(eₗ) represents the mean of the language embedding, and v(eₗ) represents the variance of the language embedding. FRDN corresponds to the inverse of FRN of Equation 1. FRDN may be applied to a portion of dimensions of the latent variable. As described above, the feature ratio ρ may be calculated based on the mean and the variance of speaker embedding and the mean and the variance of language embedding. Meanwhile, as shown in Equation 2, when ρ is 1, FRDN is replaced with SDN(x, eₛ), i.e., speaker denormalization is calculated. SDN corresponds to the inverse of SN. Also, when ρ is 0, FRDN is replaced with LDN(x, eₗ), i.e., language denormalization is calculated. LDN corresponds to the inverse of LN. Therefore, FRND may be considered as a nonlinear weighted sum of SDN and LDN. According to Equation 2, features of speaker and language embeddings may be incorporated into the latent variable.

The inverted decoder 480 may transform the latent variable preprocessed using the language embedding and speaker embedding. Here, preprocessing indicates denormalization of the speaker embedding and the language embedding. The inverted decoder 480 may obtain a transformed latent variable by applying the inverse function f⁻¹ of a normalizing flow function used in the training stage to the latent variable. The transformed latent variable may have a simpler or more complex distribution than the preprocessed latent variable. The inverted decoder 480 may transform the distribution of the latent variable based on the speaker embedding and language embedding. The transformed latent variable includes features of the input text, features of language information, features of the speaker's audio signals, and duration features.

The audio generator 490 may generate an audio signal representing a sound wave from the transformed latent variable. The generated audio signal may be identical or similar to the audio recording of the speaker selected by the user uttering the input text. Even if the specific speaker is unfamiliar with the language of the input text, a result may be generated as if the specific speaker has uttered the input text in that language.

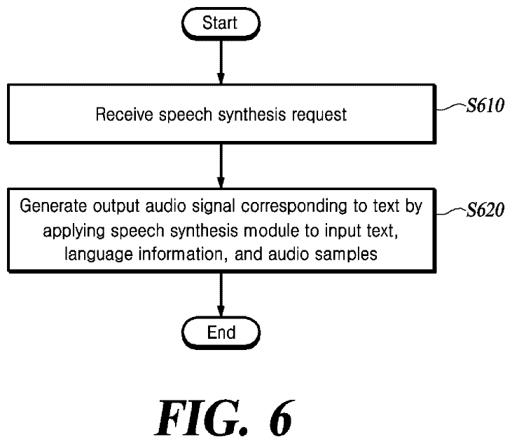

FIG. 6 is a flow diagram illustrating a speech synthesis method according to one embodiment of the present disclosure.

Referring to FIG. 6, in an operation S610, the speech synthesis apparatus receives a speech synthesis request of the user.

Here, the speech synthesis request includes input text to be synthesized into speech. In one embodiment, the speech synthesis request may include speaker information and language information desired by the user. In another embodiment, the speaker information and the language information are configured in advance by the user, and the speech synthesis apparatus may store the configured information in advance. Also, the speech synthesis apparatus may store audio samples of speakers in advance. However, there may be cases where audio samples in the requested language are unavailable for the requested speaker. In other words, the language information of the requested text may be different from the language of the audio samples of the requested speaker. For example, in the case of code-mixed synthesis, the input text may include words or characters corresponding to multiple languages. The speech synthesis request may include language information for each word or character.

In an operation S620, the speech synthesis apparatus applies a speech synthesis model to the input text, language information, and audio samples to generate output audio corresponding to the text.

Here, the speech synthesis model is trained in advance to generate an audio signal including features of the training text and features of the training audio signal, where language information of the training text and speaker information of the training audio signal are removed from the generated audio signal. In the training stage, the speech synthesis model may remove language information of the training text and speaker information of the training audio signal by normalizing the training latent variables including features of the training text and features of the training audio signal based on the language information of the training text and the speaker information of the training audio signal. Also, the speech synthesis model utilizes the training text, language embedding of the training text, and speaker embedding of the training audio signal when generating the duration of each phoneme in the training text. At this time, the speech synthesis model is trained in advance to utilize the language information inherent in the training text and the language embedding of the training text and exclude the language information inherent in the speaker embedding of the training audio signal.

In the inference stage, the speech synthesis model may include a language embedding module, a character embedding module, an encoder, a speaker encoder, a duration predictor, a projection module, an alignment unit, an inverted decoder, and an audio generator.

The language embedding module may transform the requested language information into a language embedding. In other embodiments, a language embedding may be pre-stored, and the language embedding module may not be included in the speech synthesis model.

The character embedding module may transform input text into character embeddings.

The encoder may encode character embeddings into text feature vectors.

The speaker encoder may encode audio samples to output a speaker embedding.

The duration predictor may predict phoneme duration data that includes duration of each phoneme of the input text based on the text feature vectors, language embedding, and speaker embedding. When duration of each phoneme of the input text is generated, the duration predictor may utilize the language information inherent in the input text and the language embedding but excludes the language information inherent in the speaker embedding.

The projection module may generate a distribution of the text feature vectors. Here, the distribution may include the mean and standard deviation.

The alignment unit may generate a latent variable based on the distribution of text feature vectors and phoneme duration data. As described above, in an embodiment, since the alignment unit is trained for speaker normalization and language normalization to exclude speaker and language information during the training stage, the latent variable does not include the features based on the speaker and language embeddings.

The inverted decoder may output a transformed latent variable based on the latent variable, the language embedding, and the speaker embedding. For example, the inverted decoder may de-normalize the latent variable based on the speaker and language embeddings and outputs a transformed latent variable based on the denormalized latent variable.

The audio generator may generate an audio signal from the transformed latent variable.

Although the steps or operations in the respective flowcharts are described to be sequentially performed, the steps or operations merely instantiate the technical idea of some embodiments of the present disclosure. Therefore, a person having ordinary skill in the art to which the present disclosure pertains could perform the steps or operations by changing the sequences described in the respective drawings or by performing two or more of the steps in parallel. Hence, the steps or operations in the respective flowcharts are not limited to the illustrated chronological sequences.

It should be understood that the above description presents illustrative embodiments that may be implemented in various other manners. The functions described in some embodiments may be realized by hardware, software, firmware, and/or their combination. It should also be understood that the functional components described in the present disclosure are labeled by “ . . . unit” to emphasize the possibility of their independent realization.

Various methods or functions described in some embodiments may be implemented as instructions stored in a non-transitory recording medium that can be read and executed by one or more processors. The non-transitory recording medium may include, for example, various types of recording devices in which data is stored in a form readable by a computer system. For example, the non-transitory recording medium may include storage media, such as erasable programmable read-only memory (EPROM), flash drive, optical drive, magnetic hard drive, and solid state drive (SSD) among others.

Although embodiments of the present disclosure have been described for illustrative purposes, those having ordinary skill in the art to which the present disclosure pertains should appreciate that various modifications, additions, and substitutions are possible, without departing from the idea and scope of the present disclosure. Therefore, embodiments of the present disclosure have been described for the sake of brevity and clarity. The scope of the technical idea of the embodiments of the present disclosure is not limited by the illustrations. Accordingly, those having ordinary skill in the art to which the present disclosure pertains should understand that the scope of the present disclosure should not be limited by the above explicitly described embodiments but by the claims and equivalents thereof.

What is claimed is:

1. A speech synthesis apparatus comprising:
a memory configured to store language information configured by a user and audio samples of a speaker corresponding to speaker information selected by the user; and
a processor configured to generate an audio signal corresponding to input text by applying a speech synthesis model to the input text, the language information, and the audio samples in response to a speech synthesis request of the user,
wherein the speech synthesis model is trained to generate an audio signal including features of training text and features of a training audio signal, and wherein language information of the training text and speaker information of the training audio signal are removed from the generated audio signal.

2. The speech synthesis apparatus of claim 1, wherein, when the input text includes characters corresponding to multiple languages, the language information is configured for each character.

3. The speech synthesis apparatus of claim 1, wherein the speech synthesis model is trained to remove the language information of the training text and the speaker information of the training audio signal by normalizing a training latent variable including the features of the training text and the features of the training audio signal based on the language information of the training text and the speaker information of the training audio signal.

4. The speech synthesis apparatus of claim 1, wherein, when generating duration of each phoneme of the training text, the speech synthesis model is configured to utilize the training text, a language embedding of the training text, and a speaker embedding of the training audio signal, and wherein the speech synthesis model is trained to utilize language information inherent in the training text and the language embedding of the training text and exclude language information inherent in the speaker embedding of the training audio signal.

5. The speech synthesis apparatus of claim 1, wherein the speech synthesis model includes:
a language embedding module configured to transform the language information to a language embedding;
a character embedding module configured to transform the input text into character embeddings;
an encoder configured to encode the character embeddings to text feature vectors;
a speaker encoder configured to encode the audio samples to output a speaker embedding;
a duration predictor configured to predict phoneme duration data including duration of each phoneme of the input text based on the text feature vectors, the language embedding, and the speaker embedding;
a projection module configured to generate a distribution of the text feature vectors;
an alignment unit configured to generate a latent variable based on the distribution of the text feature vectors and the phoneme duration data;
an inverted decoder configured to output a transformed latent variable based on the latent variable, the speaker embedding, and the language embedding; and
an audio generator configured to generate the audio signal from the transformed latent variable.

6. The speech synthesis apparatus of claim 5, wherein the inverted decoder is configured to de-normalizes the latent variable based on the speaker embedding and the language embedding and outputs the transformed latent variable based on the de-normalized latent variable.

7. The speech synthesis apparatus of claim 5, wherein, when generating duration of each phoneme of the input text, the duration predictor is configured to:
utilize the language embedding and the speaker embedding; and
utilize language information inherent in the input text and the language embedding and exclude language information inherent in the speaker embedding.

8. A speech synthesis method performed by a speech synthesis apparatus, the method comprising:
receiving a speech synthesis request for input text, wherein the speech synthesis request includes language information and speaker information configured by a user; and
generating an audio signal corresponding to the input text by applying a speech synthesis model to the input text, the language information, and audio samples of a speaker corresponding to the speaker information,
wherein the speech synthesis model is trained to generate an audio signal including features of training text and features of a training audio signal, and wherein language information of the training text and speaker information of the training audio signal are removed from the generated audio signal.

9. The method of claim 8, wherein, when the input text includes characters corresponding to multiple languages, the language information is configured for each character.

10. The method of claim 8, wherein the speech synthesis model is trained to remove the language information of the training text and the speaker information of the training audio signal by normalizing a training latent variable including the features of the training text and the features of the training audio signal based on the language information of the training text and the speaker information of the training audio signal.

11. The method of claim 8, wherein, generating duration of each phoneme of the training text includes utilizing the training text, language embedding of the training text, and speaker embedding of the training audio signal, and the speech synthesis model is trained to utilize language information inherent in the training text and the language embedding of the training text and exclude language information inherent in the speaker embedding of the training audio signal.

12. The method of claim 8, wherein generating the audio signal corresponding to the input text by applying the speech synthesis model to the input text includes:
transforming, by a language embedding module, the language information to a language embedding;
transforming, by a character embedding module, the input text into character embeddings;
encoding, by an encoder, the character embeddings to text feature vectors;
encoding, by a speaker encoder, the audio samples to output a speaker embedding;
predicting, by a duration predictor, phoneme duration data including duration of each phoneme of the input text based on the text feature vectors, the language embedding, and the speaker embedding;
generating, by a projection module, a distribution of the text feature vectors;
generating, by an alignment unit, a latent variable based on the distribution of the text feature vectors and the phoneme duration data;
outputting, by an inverted decoder, a transformed latent variable based on the latent variable, the speaker embedding, and the language embedding; and
generating, by an audio generator, the audio signal from the transformed latent variable.

13. The method of claim 12, wherein outputting the transformed latent variable based on the latent variable includes:
de-normalizing the latent variable based on the speaker embedding and the language embedding; and
outputting the transformed latent variable based on the de-normalized latent variable.

14. The method of claim 12, wherein, generating duration of each phoneme of the input text includes:
utilizing the language embedding and the speaker embedding; and
utilizing language information inherent in the input text and the language embedding and excludes language information inherent in the speaker embedding.
